(19) United States
(12) Patent Application Publication
(10) Pub. No.: US 2016/0161933 A1
(43) Pub. Date: Jun. 9, 2016

(54) SYSTEM AND METHOD FOR PERFORMING AUTOMATED FRACTURE STAGE DESIGN

(71) Applicant: Weatherford Technology Holdings, LLC, Houston, TX (US)

(72) Inventors: Hamed Chok, Houston, TX (US); Mojtaba P. Shahri, Houston, TX (US); Ovunc Mutlu, Houston, TX (US)

(21) Appl. No.: 14/559,976

(22) Filed: Dec. 4, 2014

(51) Int. Cl. G05B 19/042

(52) U.S. Cl. CPC G05B 19/0428; G05B 2219/24015; G05B 2219/23135

(57) ABSTRACT

Systems and methods for designing stages that optimize production for a fracturing operation of a wellbore in a reservoir formation are disclosed. To ensure efficiency, a stage design operation generally takes into account fracture efficiency information along the length of the wellbore based on known attributes and use the efficiency information to divide the wellbore into various stages. The stage design system and method provides an automated procedure for stage design that efficiently, accurately, and with minimal human involvement partitions a wellbore along its length such that the fracture operation is optimized.

### TECHNICAL FIELD

This disclosure relates generally to the field of automated stage design and in particular to methods and systems for automated fracture stage design for hydraulic fracturing.

### BACKGROUND

A common technique utilized to maximize production from permeability challenged reservoirs is fracturing. Fracturing involves creating fractures in the formation along which gas, oil, brine, or other substances may migrate to the well. These fractures are generally created to increase reservoir contact area and to maximize production. The most common form of fracturing is referred to as hydraulic fracturing which often involves injecting a high pressure liquid mixed with sand and chemicals into the formation.

A wellbore that is being fractured is often divided into different stages, and all stages may not respond the same way during a hydraulic fracture operation. For example, certain stages along a wellbore have increased fracture efficiency and thus respond better to a fracturing operation than others. A stage with high efficiency can promote a complex and highly connected fracture network which can remain open during the production and have acceptable volume of hydrocarbons in place. One way to optimize a hydraulic fracturing operation is to target the stages that have high fracture efficiency and thus increase production while minimizing the costs of operations. Thus the process of selecting and designing different stages is an important part of increasing overall efficiency of the operation.

Current industry practice for stage selection and design generally involves using single or multiple logs to perform a screening analysis along a wellbore. This analysis is generally quick and results in calculating an indicator which is then used as a proxy to indicate areas with high fracture potential. This process requires a user to input a certain set of parameters for stage selection and design. Once the indicator is calculated, location, number, and size of the different stages are usually manually selected. This is an oversimplified analysis of fracture efficiency, time consuming, non-repeatable, and in no way efficient.

Thus, currently used methods of performing fracturing stage design are inefficient and have certain shortcomings. The following disclosure addresses these and other issues.

### SUMMARY

In one embodiment a non-transitory program storage device, readable by a processor is provided. The non-transitory program storage device includes instructions stored thereon to cause one or more processors to receive a plurality of input parameters, each input parameter relating to a wellbore in a reservoir formation, to calculate one or more efficiency indices for the wellbore based on the input parameters, wherein each of the one or more efficiency indices may vary along a length of the wellbore, and to select one or more stage locations for the wellbore, each stage having a particular length, where the selection is done by utilizing an optimization process used to select stage locations based at least in part on at least one of the one or more efficiency indices having a minimal total intra-stage variation along the length of the wellbore.

In another embodiment, a method for designing fracture network staging for a fracturing operation is provided. The method includes receiving a plurality of input parameters that each relates to a wellbore in a reservoir formation, calculating one or more efficiency indices for the wellbore based on the input parameters, where each of the one or more efficiency indices may vary along a length of the wellbore, and selecting one or more stage locations for the wellbore, each stage having a particular length, where the selection is done by utilizing an optimization process used to select stage locations based at least in part on at least one of the one or more efficiency indices having a minimal total intra-stage variation along the length of the wellbore.

In yet another embodiment, a system is provided. The system includes in one embodiment, a memory, a display device, and a processor operatively coupled to the memory and the display device and adapted to execute program code stored in the memory. The program code is executed to receive a plurality of input parameters, each input parameter relating to a wellbore in a reservoir formation, to calculate one or more efficiency indices for the wellbore based on the input parameters, wherein each of the one or more efficiency indices may vary along a length of the wellbore, and to select one or more stage locations for the wellbore, each stage having a particular length, where the selection is done by utilizing an optimization process used to select stage locations based at least in part on at least one of the one or more efficiency indices having a minimal total intra-stage variation along the length of the wellbore.

### BRIEF DESCRIPTION OF THE DRAWINGS

FIG. 1 shows an example of fracture propagation at different stages around a wellbore.

FIG. 2 shows a user interface screen for entering certain attributes as inputs to an automated stage design procedure, according to one or more disclosed embodiments.

FIGS. 3A-3F show graphs of calculated absolute fracture efficiency index, relative geomechanical and reservoir efficiency indices and overall relative fracture efficiency index along the length of the wellbore, according to one or more disclosed embodiments.

FIGS. 4A-4B show flowcharts for an automated stage design operation, according to one or more disclosed embodiments.

FIG. 5 shows a flowchart illustrating a stage design operation involving constrained steepest-descent based optimization of depth partitioning, according to one or more disclosed embodiments.

FIG. 6 shows a flowchart illustrating a stage design operation involving a local optima sampler, according to one or more disclosed embodiments.

### DESCRIPTION OF DISCLOSED EMBODIMENTS

In the following description, for purposes of explanation, numerous specific details are set forth in order to provide a thorough understanding of the inventive concept. As part of this description, some of this disclosure's drawings represent structures and devices in block diagram form in order to avoid obscuring the invention. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art of data processing having the benefit of this disclosure.

In permeability challenged reservoirs, one of the primary goals of a fracturing operation is to create an extensive and well-connected fracture network that can remain open during production. However, not all locations around a well respond in the same manner to fracturing. Some areas respond more effectively than others. To maximize production from these areas, the wellbore is generally divided into different stages so that the areas within each stage have approximately a homogeneous response. The different stages are then treated differently during the fracturing operation depending on their fracture efficiency.

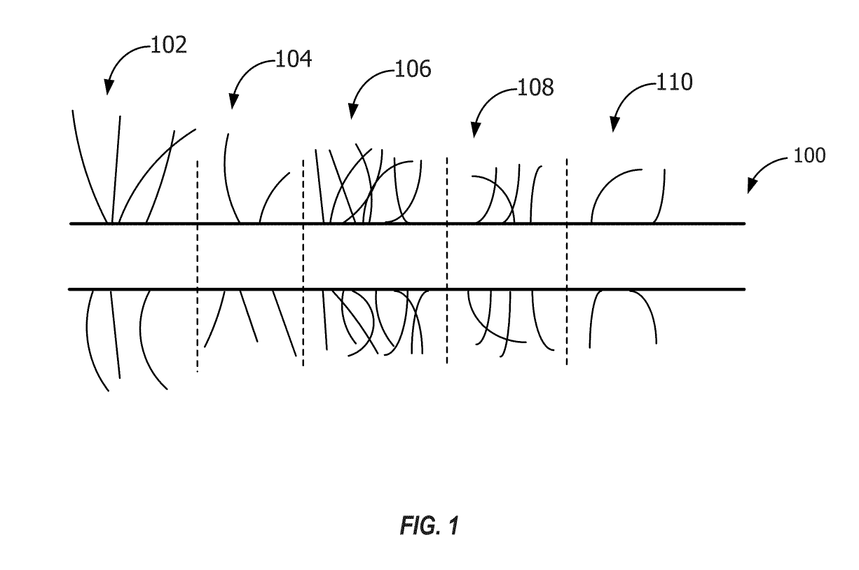

FIG. 1 illustrates an example wellbore 100 with propagating fractures after a fracturing operation has been performed. As can be seen, the number and size of fractures along the length of the wellbore 100 varies depending on location. Some areas promote fracture complexity while others host regular fracture pattern. Wellbore 100 has been divided into five different stages 102-110 accordingly. As shown, the stages vary in length and exhibit different behavior along the length of the wellbore. For example, stage 106 produces a large number of fractures along its length, while fracture 110 produces only a few. Knowing these properties ahead of time would allow a fracturing operation to treat stage 106 differently than stage 110, thus increasing the efficiency and productivity of the operation and the wellbore. This would also allow skipping stages that fall below a critical threshold efficiency value.

In addition to geomechanical properties affecting fracture geometry along the length of a wellbore, reservoir properties may also affect production from a fracture network. For example, properties such as water saturation or porosity can affect the overall fracture efficiency. If water saturation is high or porosity is low in a reservoir, for example, the efficiency of the reservoir will be low which affects the overall efficiency of the fracturing operation. Thus, similar to geomechanical properties, reservoir properties may need to be taken into account to ensure they have uniform properties along the length of each stage.

A stage design operation would need to predict fracture efficiency along the length of the wellbore based on known attributes and to use the predicted efficiency to divide the wellbore into various stages. In the past this was done manually and through a non-integrated quick look analysis which could be time consuming and give inaccurate and non-repeatable results. One embodiment of the present invention provides an integrated and automated procedure for selecting and designing stages that is quick, efficient, highly accurate, and repeatable. The automated procedure employs an optimization approach, which mathematically formalizes the notion of stage design accuracy.

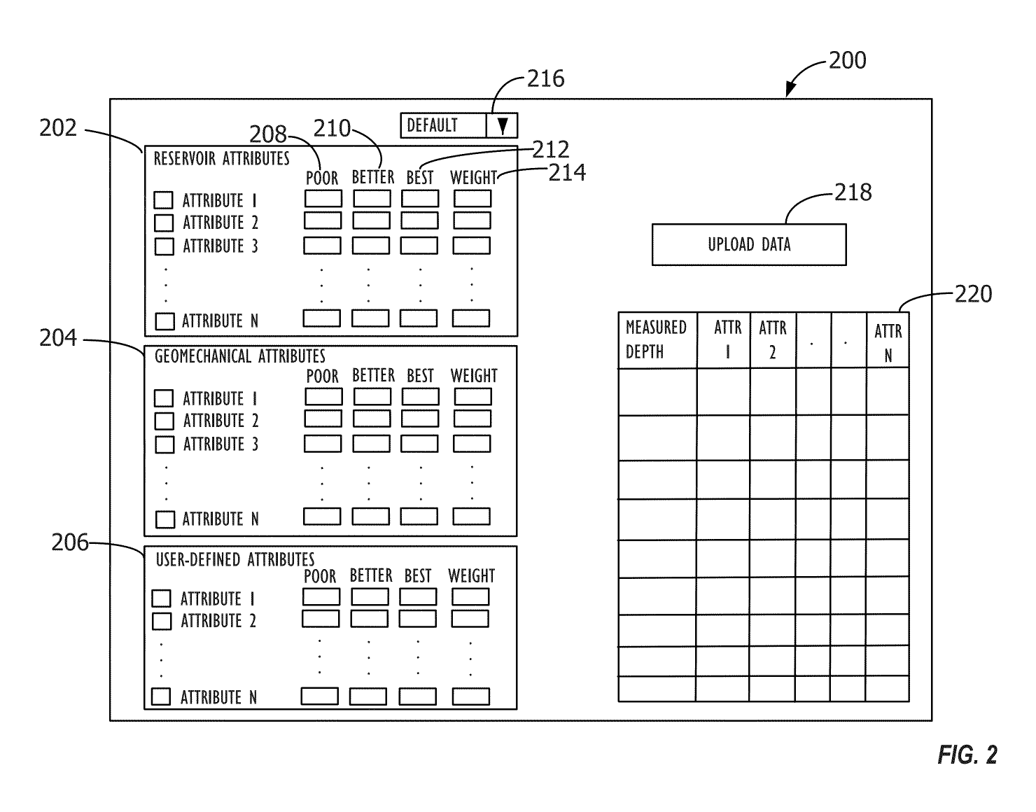

In one embodiment, the fracture analysis and design of fracture networks operation involves presenting a user with a user interface screen such as the user interface screen 200 of FIG. 2. User interface screen 200 includes a section 202 for selecting reservoir attributes. The number and selection of reservoir attributes may vary in different embodiments. In one embodiment, reservoir attributes may include TOC, water saturation, permeability, porosity, percentage of clay, and percentage of Kerogen. Any number of other reservoir attributes may be used in other embodiments. A user may choose which reservoir attributes to include in an analysis by selecting the checkbox next to that attribute. Once a reservoir attribute is selected, the user may have the option of choosing a weight to assign to the selected attribute by inputting a number in the reservoir attribute's corresponding weight input box 214. This is to enable the user to select the level of importance given to a certain attribute. Alternatively, the weight may be assigned a default value that is hardcoded into the program or stored in a calibration file. For example, in one embodiment, if the default choice is selected in the dropdown box 216, the weight numbers may be assigned based on their default values. The dropdown box 216 may also provide other options for predetermined weight values. For example, in addition to linear weighting, other non-linear weighting of different attributes can be used to find the overall fracturing efficiency of the wellbore. In addition to the weight input boxes 214, boxes 208, 210 and 212 provide an option for a user to input cut-off values corresponding to each reservoir attribute to determine poor, better, and best ranges. These values provide thresholds by which the program may determine where each reservoir attribute falls. For example, in one type of wellbore, a permeability value below a certain value (e.g., 100, in one embodiment) may be considered bad for overall fracturing efficiency and a permeability value above a certain value (e.g., 250, in one embodiment) may be considered best. These values may then be entered into box 208 and 212 in the row corresponding to reservoir attribute for permeability. As an alternative, to a user inputting these values, they may be predetermined, in one embodiment. For example, when the default setting is selected in box 216, the values for poor 208, better 210, and best 212 may be selected based on default predetermined values or for a specific hydrocarbon play. As an alternative to this step-wise discretization scheme, continuous scaling functions may be utilized to map attribute values to desired continuous ranges as one skilled in the art would appreciate.

In addition to reservoir attributes, user interface screen 200 includes a section 204 for inputting geomechanical attributes and a section 206 for inputting user-defined attributes. Geomechanical attributes may include one or more of facture density, closure stress gradient, formation anisotropy, UCS, Friction angle, Poisson's ratio, Young's Modulus, critically stressed fracture potential, fracture closure index, stress anisotropy, and fracture height index. Any other geomechanical attribute may also be included. As with the reservoir attributes 202, a user may select which attribute to include in the analysis and may input values for poor 208, better 210, best 212, and weight 214 for each attribute. Alternatively, the user may choose to use predetermined values. The user-defined attributes section 206 may include any other attributes the user chooses to include in the analyses. For example, user-defined attributes may include mineral content, gas content, fracture cement fill type, and the like. In one embodiment, the user can define and add as many user-defined attributes to the user-defined attributes section 206 as the user wishes. Again, once these attributes are chosen, the user may input values for poor 208, better 210, best 212, and weight 214 for each attribute or may choose to use predetermined values. It should be appreciated that the integrated stage design procedure is not bound to any particular weighting scheme. Rather different embodiments may choose to implement different weighting options e.g., linear or any non-linear form. In one embodiment, the user also has the option of uploading data from a file for the chosen attributes. Various methods known in the art can be used for uploading the data. The uploaded values may be displayed in table 220. As shown, table 220 displays values of each of the attributes at each measured depth. Based on these values, the integrated procedure for stage design may determine and predict how each area of the wellbore will respond to a fracturing operation.

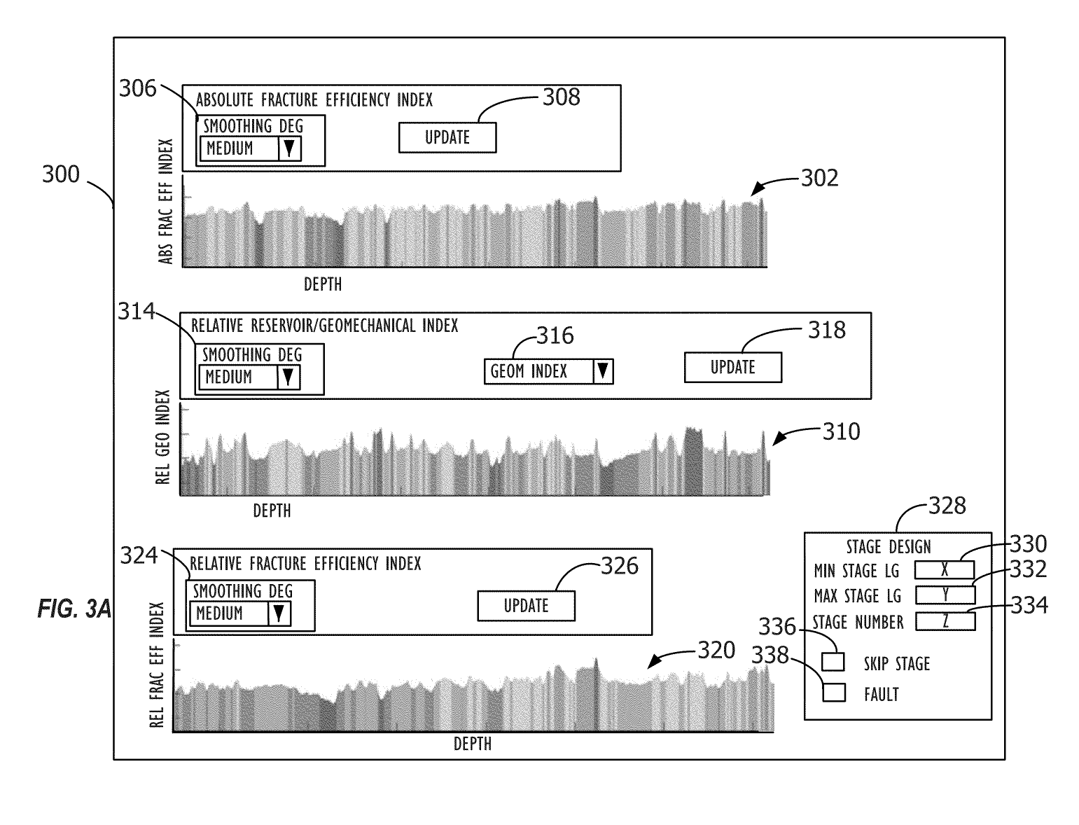

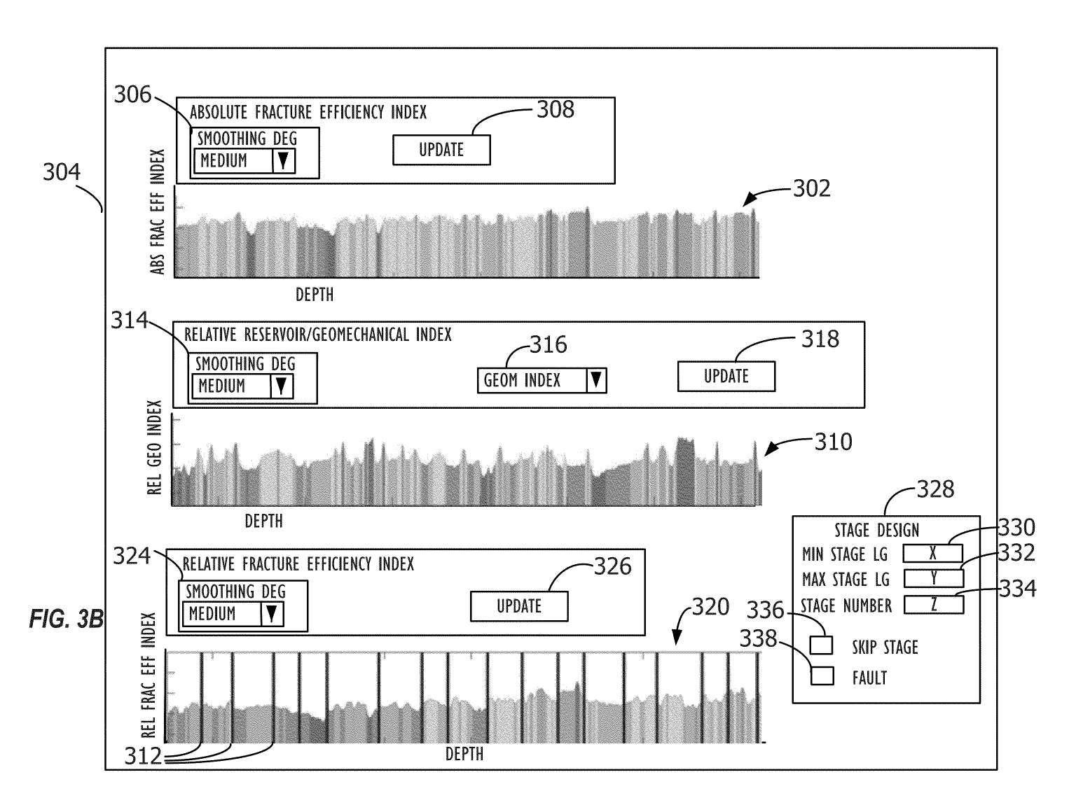

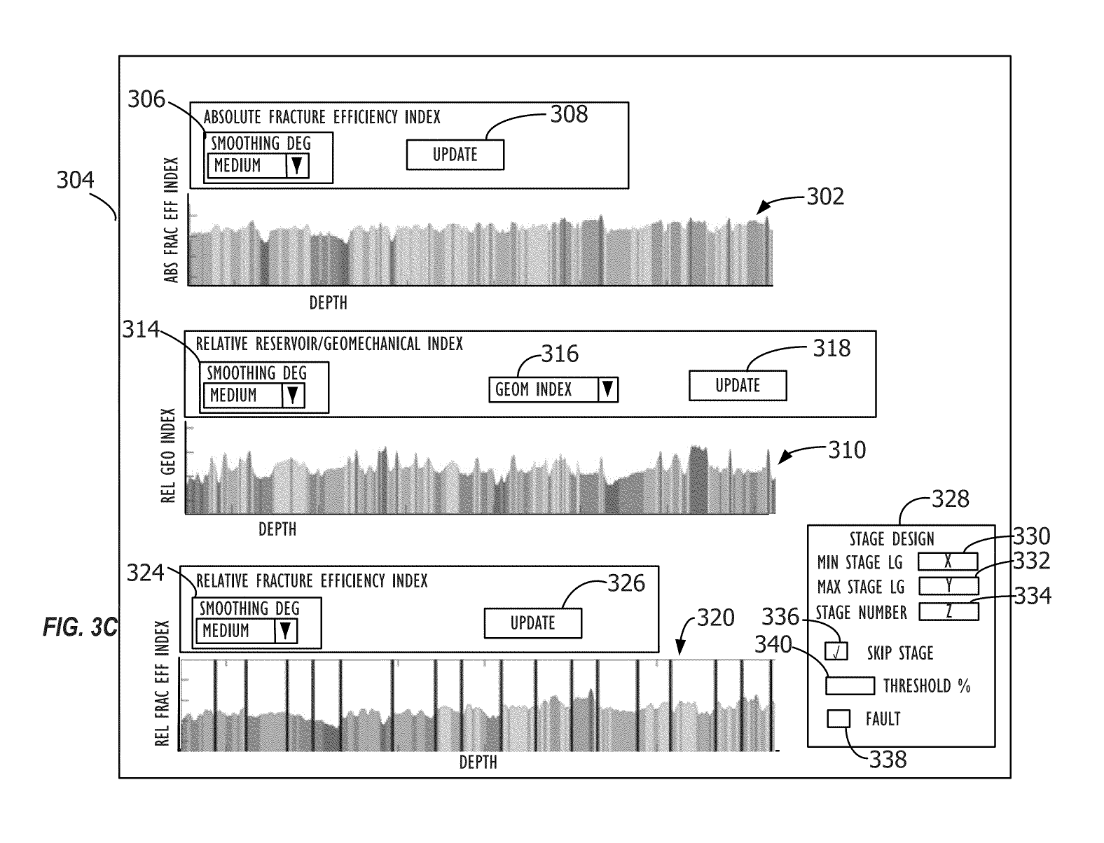

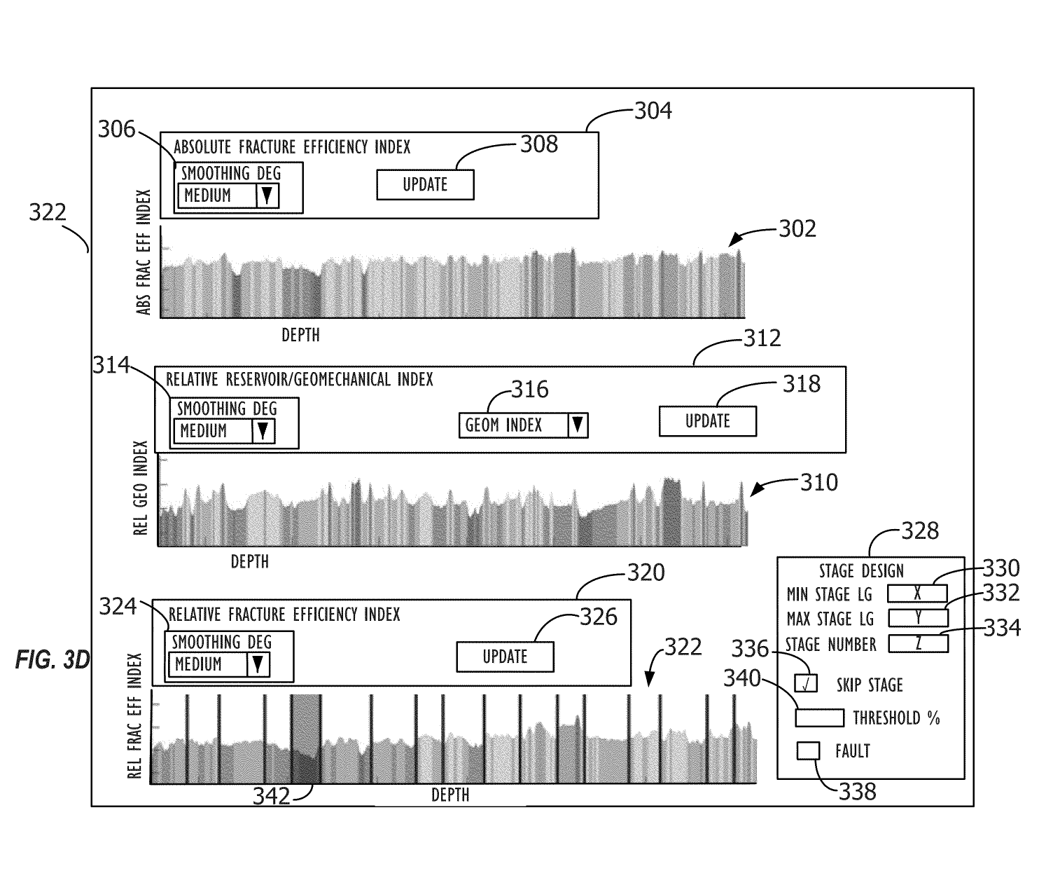

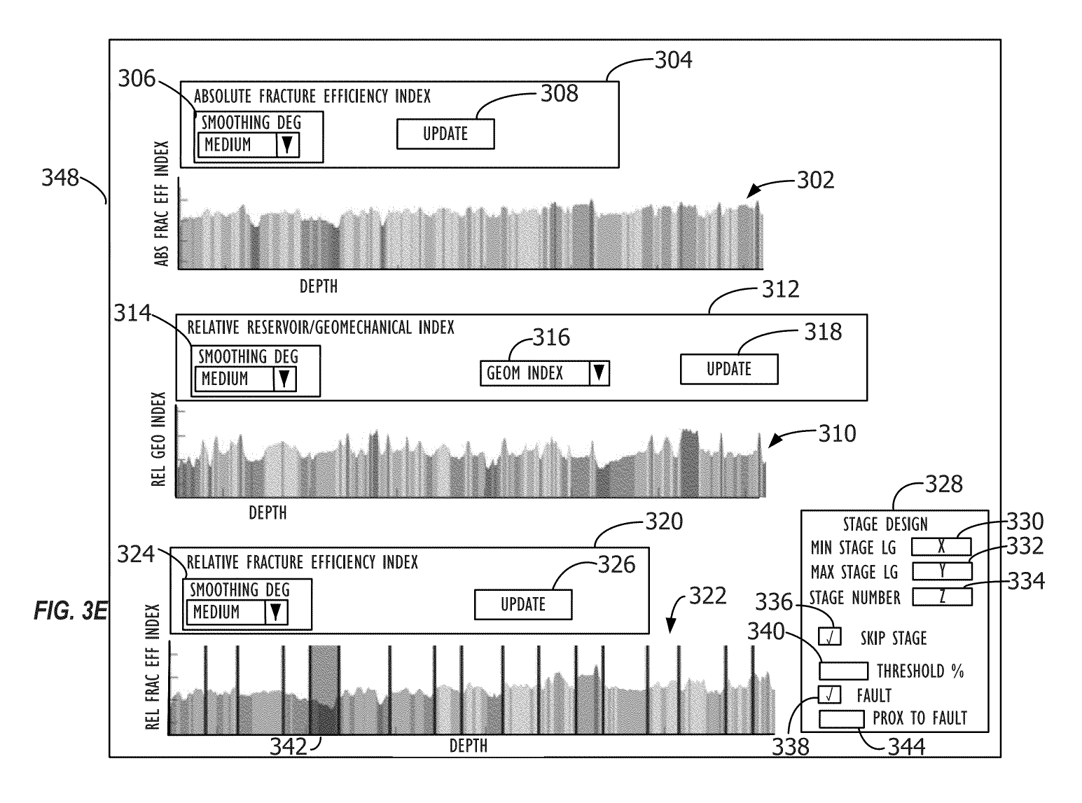

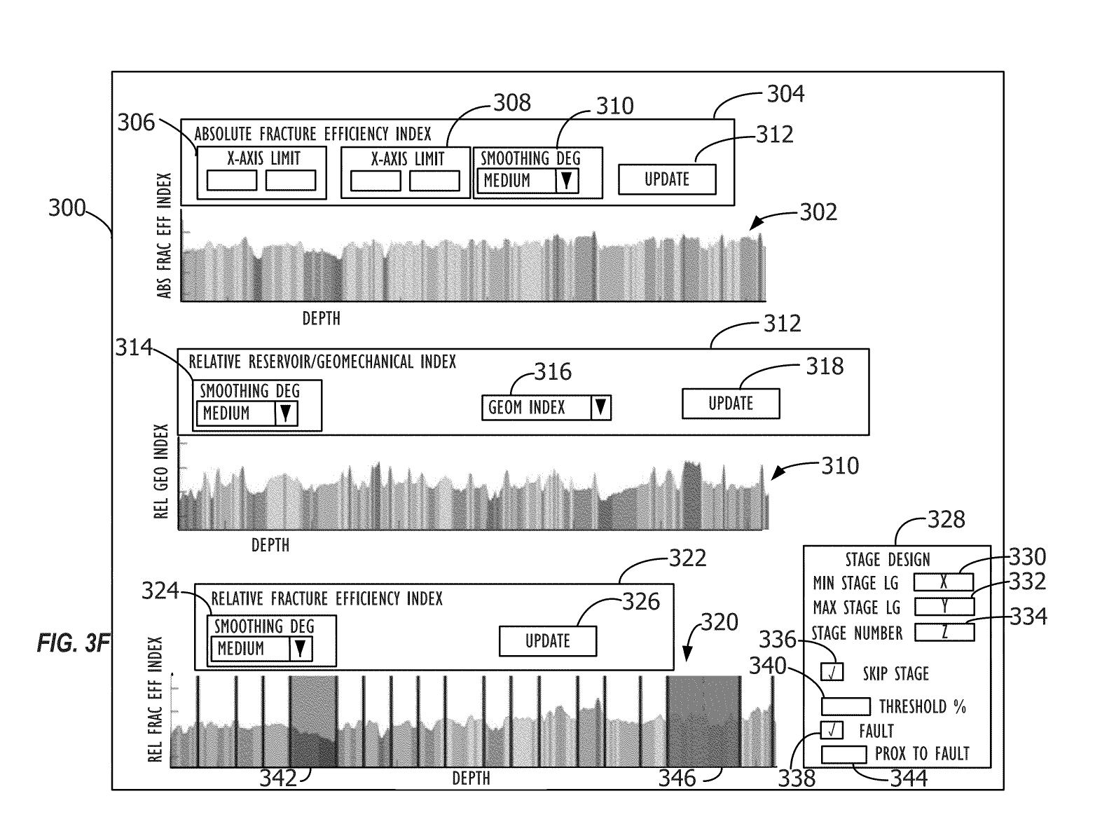

In one embodiment, once the attributes and their weights are selected and data is uploaded, the user may select to run an analysis on the wellbore. The results of such an analysis may be displayed to the user in a variety of different forms. For example, they may be presented on a graph, in a text file or in a table format. In one embodiment, the results are shown in graphs such as the ones shown in screen 300 of FIG. 3A.

In one embodiment, screen 300 includes a graph 302 for displaying an absolute fracture efficiency index at each measured depth. The absolute fracture efficiency index is a value calculated based on cut-off values and weights to evaluate the fracturing efficiency of a wellbore as a whole. For example, if all the attribute values at a specific depth fall into the best region based on the cut-off values, this depth will be determined as having acceptable fracturing efficiency. The absolute fracture efficiency index could help a user determine whether or not a wellbore is suitable for fracturing.

The screen 300 provides a variety of optional features for a user to select how to view the graphs and what to view on each graph. For example, it provides an option for the user to select a smoothing degree 306 for the graph 302. The user may select a medium smoothing degree and press on the update button 308 to view the graph 302 in the form illustrated.

Screen 300 also includes a graph 310 for illustrating relative fracture efficiency index curves. The relative fracture efficiency index is calculated by normalizing the fracture efficiency index through the length of the wellbore based on a weighting scheme that takes into account the reservoir, geomechanical and user-defined attributes and their weights and calculate an index that predicts the efficiency of fracturing at each depth in the wellbore. The weighting scheme could be either linear or non-linear. In particular, the weighting scheme can allow the selection of which types of attributes to take into account. For example, the relative fracture efficiency index may be calculated based on only one of the three types of reservoir, geomechanical, or user-defined attributes. Graph 310 can display the relative fracture efficiency curve calculated based on each of these types of attributes to show the contribution of each part on the overall efficiency. In one embodiment, the user has the option of selecting which type of relative fracture efficiency curve (i.e., calculate based on reservoir, geomechanical, or user-defined attributes) to plot by using the dropdown box 316 and pressing on the update button 318. The user may also select a smoothing degree 314 for the graph 310.

In addition to the absolute fracture efficiency index and the relative reservoir or geomechanical index, screen 300 also provides a graph 320 for viewing the overall relative fracture efficiency index at each depth. As discussed above, the overall relative fracture efficiency index takes into account the weight of each selected attribute to calculate an index that predicts the relative efficiency of fracturing at each depth in the wellbore. The weighted combination of selected attributes is normalized along the well length to form the relative fracture efficiency index. This index may be used to show what places in the wellbore provide a better fracturing efficiency relative to others for each wellbore, even if the wellbore as a whole does not have a high absolute fracture efficiency index. In other words, the values of cut-offs are not used for calculating the relative efficiency index. Again, as with plot 302 and 310, a smoothing degree may be selected through the dropdown box 324 and by pressing the update button 326.

After the various fracture efficiency indices are calculated, the information can be used to automatically design stages for the wellbore. In one embodiment, this process may be started by a user using the graphical interface of FIG. 3A. In another embodiment, other methods may be used to signal a user's desire to initiate design of stages for the wellbore. In yet another embodiment, the process may begin automatically without user intervention. In the embodiment, where the user uses the graphical interface of FIG. 3A, the user may input values for a minimum stage length 330, maximum stage length 332, and stage number 334 and run the procedure to select and design the stages of the wellbore based on the entered length and numbers. The stage length and numbers may be provided by the user or alternatively, a fully automated option may be used to select the optimized stage number and locations. Once the procedure is complete, the screen 300 may be updated to screen 304 of FIG. 3B.

Using an automated stage design algorithm, the well can be divided into different stages with least total intra-stage variation of relative fracture efficiency index as shown in plot 320 by lines 312. These lines divide the wellbore along its length into different stages. The stages are automatically selected based on a combination of values for minimum and maximum stage length, number of stages and the relative fracture efficiency index for the wellbore at each depth. The automated stage design algorithm involves an optimization process used to select stage locations yielding a minimum total fracture efficiency index variation within each stage. The optimization goal is to keep the efficiency indices as uniform as possible within each stage. Integrating all of the staging parameters and input curves, the algorithm automatically chooses the dividing lines for the stages, thus reproducibly, accurately, and efficiently designing the stages. The plot not only shows how to stage the wellbore, it can be combined with absolute fracture efficiency index to illustrate the efficiency of the fracturing operation at each stage, thus allowing the user to determine how to treat each stage. Although shown here on a graph, it should be understood that the resulting stage design can be outputted and presented to the user in a variety of different manners known in the art.

The automatic stage design algorithm and procedure may provide an option to skip stages. This is illustrated in FIG. 3C, where the skip stage box 336 is selected. In one embodiment, selecting this option allows the user to choose to skip stages that fall below a predetermined threshold. For example, a user may decide that some areas of the wellbore are not worth fracturing and decide to skip those areas. In such a case, the user may select the skip stage box 336 and enter a value into the threshold box 340. The threshold value may be, for example, a minimum value for the average in-stage relative fracture efficiency index below which the user desires to skip stages. If the average value for the relative fracture efficiency index for any of the stages falls below the entered threshold, then the user may decide not to fracture one, some, or all of such stages, thus creating a potential to achieve a better staging by readjusting the stage locations so as to minimize the total intra-stage variability over only the stages which the user does decide to fracture. The result, in one embodiment, is illustrated in FIG. 3D. The stage 342 is skipped in this example, because it falls below the threshold entered in the previous screen. When one or more stages are skipped, the algorithm rearranges the staging by directing the optimization to minimize the total intra-stage efficiency variability over the stages to be fractured while ignoring the variability over the stages to be skipped. As it will be described later, other embodiments may involve staging optimization based on multiple efficiency curves simultaneously, in which case it should be noted that the skipping threshold may be a vector instead of a value.

The algorithm may also provide the option of selecting whether to take faults into account. In general, it is preferred not to fracture areas that are near a fault or other similar geological features. By selecting the Faults box 340, as shown in FIG. 3E, the user can choose to take fault(s) into account when designing the stages. Once the Faults box 340 is selected, the user may enter a value for proximity to fault into box 344 to indicate the distance an area of the wellbore should be to a fault or other similar geological feature to skip that area. Proximity to fault can be different for each fault depending on its characteristics. Once the value is entered, automated stage design can be performed to skip the areas close to faults. This is shown in FIG. 3F. As illustrated, the area marked as 346 is determined to be too close to the fault based on the calculations and is thus chosen to be skipped. A distinction must be made between skipping stages and skipping areas close to faults. In the latter instance, the algorithm must treat any two reservoir regions separated by a fault-inflicted region as two separate staging tasks all while assuring that all staged zones satisfy the overall requirements such as, for instance, the total number of all collective stages from all zones. Thus, as shown the automated stage design procedure provides a comprehensive, efficient, and accurate method by which to design a fracture network staging that provides the options of skipping desired stages and taking into account faults.

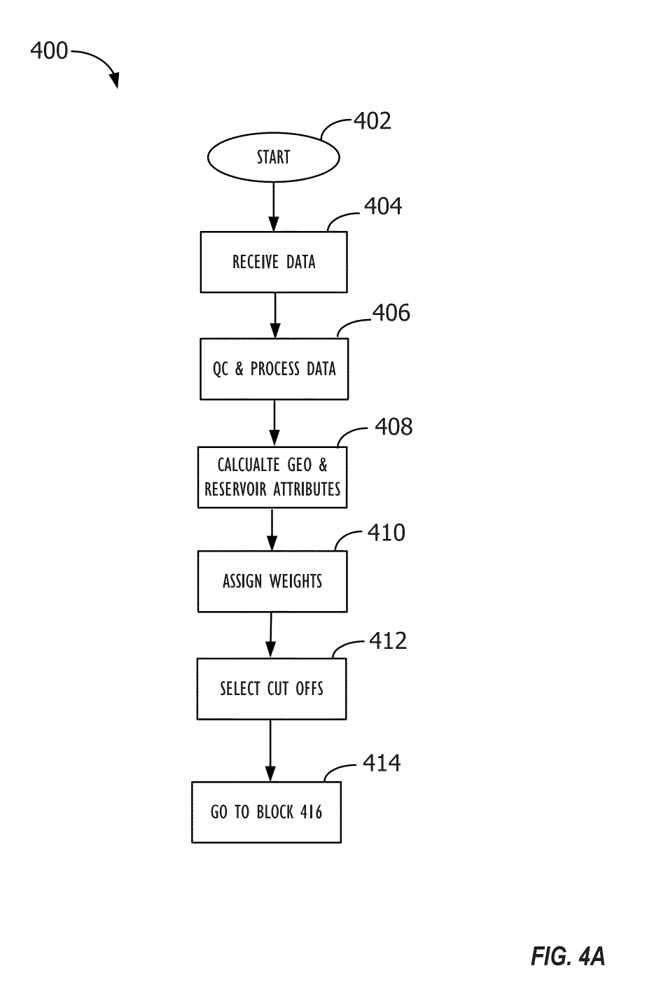

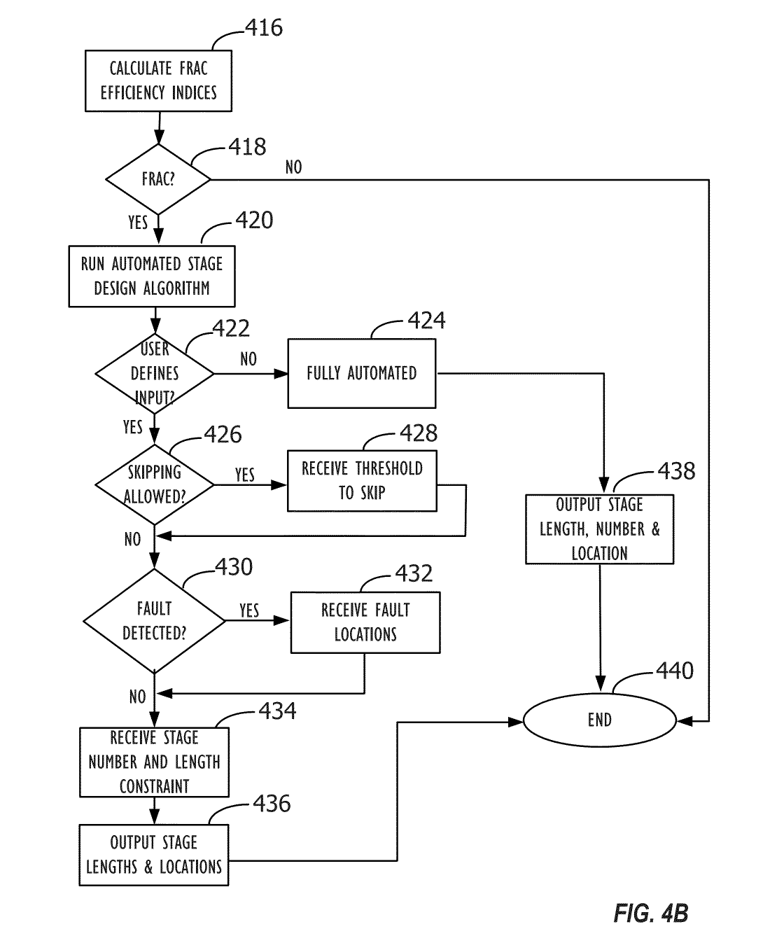

FIG. 4A provides a flow chart for an automated stage design operation, according to one embodiment. Operation 400 starts (block 402) by receiving data (block 404) from one or more sources. These sources may include field data, or data provided by cores, logs and may include cutting or drilling operational data. The received data is quality controlled and processed (block 406) to assure its accuracy before it is used to calculate geomechanical and reservoir attributes (block 408). These attributes are generally calculated for each measured depth of a wellbore such that the operation has a list of geomechanical, reservoir or other user-defined attributes for each measured depth. Generally, values for one or more of the attributes change at each depth. The operation can then use these values to make calculations and predict the behavior of the wellbore at each depth as a result of a fracturing operation. In an alternative embodiment, the data that is received at block 404 includes the geomechanical and reservoir attributes needed for the calculations and thus there is no need for the program to calculate those attributes at block 408.

Once the geomechanical, reservoir attributes, or user-defined attributes are determined (or received), weights are assigned to each of those attributes (block 410). In one embodiment, this is done by operation 400 based on predetermined criteria or specific hydrocarbon plays. For example, if a default setting is selected, the operation 400 may assign a predetermined weight for each given attribute. Alternatively, a user may be able to enter desired weights for each attribute that will be used in the calculations. In addition to weights, cutoffs are also assigned to each attributes (block 412). In one embodiment, cutoffs are values that determine the quality of the attribute. For example, water saturation above a certain threshold value may be designated as a poor value, while water saturation below another certain threshold value may be considered a best value. Values in between the two threshold values may be considered average values. In one embodiment, default cutoff values are assigned for each hydrocarbon play. Alternatively, a user may be able to enter the cutoff values for one or more of the attributes.

After the attributes are calculated and weights and cutoffs are assigned, the operation moves to block 416 of FIG. 4B (block 414), where various fracture efficiency indices (e.g., absolute fracture efficiency index and relative fracture efficiency index) are for the wellbore (block 416). As discussed before, the absolute fracture efficiency index may be used to evaluate the efficiency of fracturing the wellbore as a whole. In one embodiment, the operation thus determines, based on the calculated absolute fracture efficiency index, whether the wellbore should be fractured (block 418). This is done, in one embodiment, based on a predetermined threshold value against which the calculated absolute fracture efficiency index may be compared. For example, if the absolute fracture efficiency index is lower than a predetermined threshold, then the operation may determine that the wellbore is not suitable for fracturing. If the operation determines that the wellbore should not be fractured, then it moves to block 440 to end the operation. In one embodiment, even when the operation determines that the wellbore should not be fractured, an option may be provided to the user to run the automated stage design algorithm for the wellbore (block 420). This may occur, in instances where the wellbore has to be fractured or may be done to provide the user with more information about the wellbore to help the user decide on the location, number and length of each stage.

Once the fracture efficiency indices for the wellbore have been calculated and it is determined that the wellbore should be fractured, an automated stage design algorithm may begin running (block 420). The automated stage design algorithm may use the values from a chosen fracture efficiency index curve (e.g., absolute or relative) to automatically select and design stage(s) for the wellbore yielding nearly uniform fracture characteristics along each stage. In one embodiment, the automated algorithm is designed so as to run on multiple index curves if the user selects this option. Instances wherein multiple index curves may be input to the algorithm include cases when each raw attribute curve is viewed as an individual indicator of fracture efficiency and when the user does not want any loss of information as a result of the aggregation of the raw curves into a single index curve. More generally, multiple index curves may be fed to the automation algorithm when various fracture efficiency indices are generated each using a different weighting/aggregation scheme. This is because each index may be viewed as an aggregate feature and by having a collection of aggregate features, loss of information resulting from each single aggregation may be reduced or avoided altogether. Running the stage automation algorithm may be done completely automatically or the user may have the option of selecting certain parameters in the design. Thus, at this point, the operation determines if there are any user inputs to the stage design algorithm (block 422). If it is determined that no user inputs should be used in stage design, then the operation is indicted as fully automated (block 424). In such a case, the automated operation calculates and outputs the stage lengths, number, and locations of the designed stages (block 438). The results may be shown to the user in a graphical form (e.g. on a graph), tabular manner, or any other method known in the art, before the operation ends (block 440).

When at block 422 it is determined that the operation is not fully automated and the user should input parameters, then operation 400 moves to determine if skipping stages is allowed (block 426). This may be decided by a user or may be predetermined by the operation. When skipping stages are allowed, the operation receives a threshold value for skipping (block 428) stages. This value, may, for example be a value for the average relative fracture efficiency index for a stage below which the stage should be skipped. After receiving the threshold value or when it is determined that skipping stages is not allowed, the operation moves to determine if a fault is detected (block 430). In one embodiment, this step may be optional or only performed when selected by a user. When a fault is detected, the operation moves to receive the fault's coordinates and characteristics (block 432). After receiving the fault coordinates or when no fault is detected, the operation moves to receive stage design constraint (block 434). This may include minimum and maximum length for the stages and the number of stages a user desires to have. Other stage related information may also be provided and taken into account. Once the data has been received, the operation calculates and outputs the stage lengths, number and location of the designed stage network (block 442) for the wellbore. The results may be shown to the user (block 436) in a graphical form (e.g. on a graph), may be presented in tabular manner, or any other method known in the art, before the operation ends (block 440). Thus, operation 400 as detailed in FIGS. 4A-4B efficiently and accurately performs a stage network design for a given wellbore by taking into account various parameters and automatically designing an appropriate network.

The stage design algorithm provides full autonomy in the process of dividing a reservoir zone into fracture stages by employing an optimization-driven staging approach for real-time operational decision making, therefore assuring consistency and repeatability of the interpretation in addition to relieving the human analyst from a laborious, error-prone, and often-subjective interpretation.

In general, the stage design automation algorithm casts the stage design problem as that of discrete optimization and solves it. The essence of the optimization relies on the fact that any partitioning of the wellbore area into fracture stages given fracture efficiency indices can be objectively assessed in terms of a measure that quantifies how well the efficiency index curves are segmented into stages. The algorithm then seeks to optimize such measure. An objective measure for assessing the quality of any partitioning should reward partitions wherein individual stages are as homogeneous in terms of their efficiency indices as possible. It follows that by defining the homogeneity of the efficiency indices for any given stage, the total stage homogeneity may serve as an objective measure of the quality of any stage design (i.e., partitioning). If the collection of efficiency indices at any fixed depth are referred to as a sample then the efficiency index homogeneity for any stage may be defined as the average distance from all in-stage samples to the mean in-stage sample, assuming any particular distance function (e.g., Euclidean). Hence, the lower the average distance to the mean is, the more homogenous the stage is. Thus the algorithm should seek to minimize the sum of all intra-stage average distances.

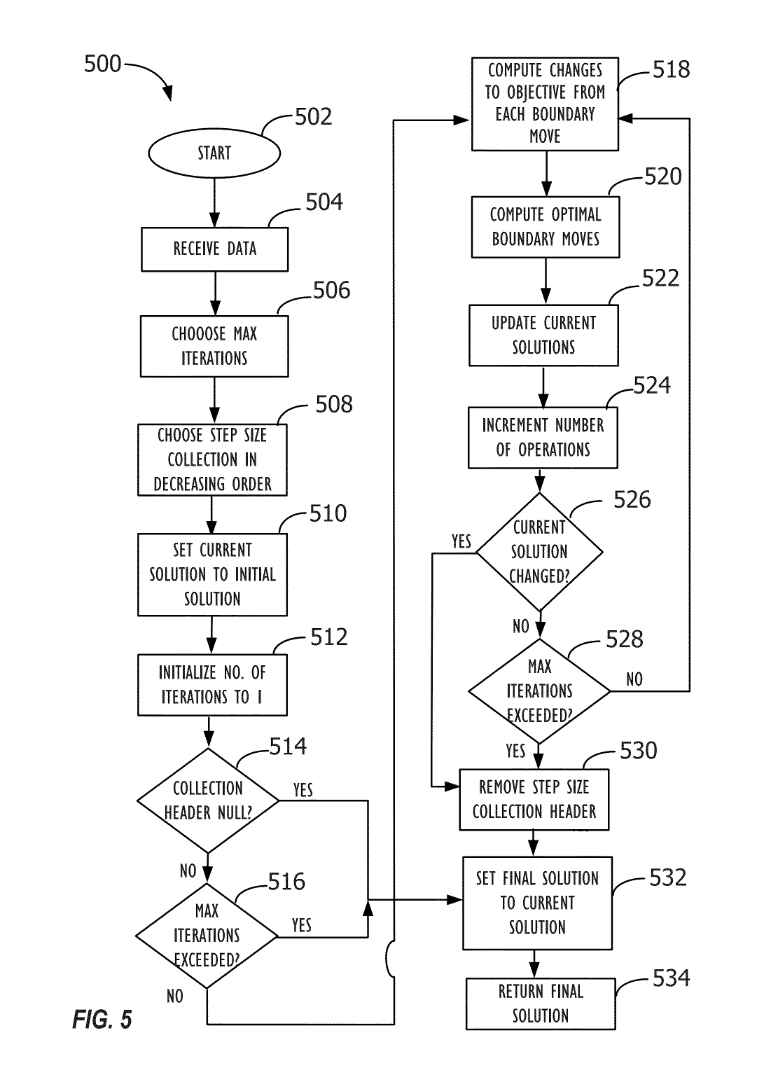

In one embodiment, to minimize the objective measure of stage partitioning, the automation algorithm makes use of a local optimization module illustrated by operation 500 of FIG. 5. For any given initial partitioning, such an optimization module is able to locally improve the initial partitioning. If the objective measure is viewed as a function of the partitioning, then the process is equivalent to a local function minimization given an initial solution. It shall be well-known to someone skilled in the art that any locally based optimization may only yield a suboptimal solution, one that may be severely inferior to any globally optimal solution. To remedy such situation, a separate module capable of efficiently sampling initial solutions may be utilized in conjunction with the local optimizer. That is, it is possible to use the best locally optimal solution from a pool of sampled local solutions as an estimate for a globally optimal solution. It can be theoretically shown that the approximation by the best generated locally optimal solution will improve as the sample size increases and that it will asymptotically converge to a globally optimal solution.

The locally driven objective function minimizer follows an iterative strategy. Given the initial stage design, it is possible to assess the effect of moving one stage boundary to the left or the right by a fixed step size on the value of the objective function. The differences in the objective value from all individual fixed-step left and right boundary moves may be computed. The combination of boundary moves that yield the largest sum of all individual decrements to the original objective value may be chosen. Once all chosen boundary moves are applied, the new objective value may be computed and the process may be iterated until convergence (i.e., when no boundary moves are possible). The process of selecting the combination of the boundary moves at each iteration may be cast as an integer programming problem. Theoretically, such an iterative process is convergent given that the objective value is lowered at every iteration and that there is a finite set of partitions (solutions) to search-through. It should be noted that this optimization process is subjective to the choice of the prefixed step size. It is therefore beneficial if the entire process is repeated for different step sizes. In one embodiment, an ordered collection of decreasing step sizes is predetermined and the optimization process is iteratively sequenced such that the terminal solution using one fixed step size feeds into the initial solution of the optimization process with the next lower step size and so on.

The local optimization module of the automated algorithm for stage partitioning is outlined step-by-step in operation 500 of FIG. 5. The process starts by receiving the input efficiency index curves, staging constraint parameters (e.g., minimum/maximum stage length), and initial stage design (block 504). The sub-process in block 506 sets the maximum allowed number of iterations and the operation moves on to block 508 to set the collection of decreasing step sizes, in one embodiment. The operation then initializes the current stage design to the given initial one (block 510) and initializes the counter for the number of iterations to 1 (block 512). The iterative steps are illustrated in the sub-processes of blocks 514-530. The operation first checks for the terminating conditions, respectively, looping over all step sizes (block 514) and reaching the allowed number of iterations (block 516). When neither of these two conditions is satisfied, the iterated sub-processes are performed (blocks 518, 520, 522, 524, and 526). In block 518, the operation evaluates change in the objective function as a result of each individual boundary move. The sub-process of block 520 involves performing the optimization task for computing the optimal combination of boundary moves that yields the largest decrease in the objective function. In block 522, the operation updates the current stage design given the optimal boundary moves obtained in block 520. In block 524, the number of iterations is incremented by one. Block 526 checks whether or not the new solution is different from the previous one. If the check is negative, the process moves on to block 528 and otherwise it skips to block 530. In block 528, the operation checks the iteration counter against the maximum allowed number of iterations. If the iteration counter is less than the allowed maximum then the process reiterates starting back from block 518, otherwise it moves to block 530. In block 530, the operation directs the process to change the step size which defines the allowed margin for any boundary move. When either of the two loop controls (blocks 514 and 516) evaluates to true, the operation moves past the iterated sub-processes to block 532 which sets the final solution (stage design) to the last updated solution. In block 534, the operation returns the final stage design solution.

It should be noted that assuming every sample within the wellbore area is sampled at a constant depth interval, then every stage partition (i.e., solution) of the set containing all the samples within the wellbore area mathematically corresponds to a unique integer composition of the number of samples where the number of terms in the composition is equal to the number of stages and each term in the composition is within any imposed stage length constraints. The solution space is therefore on the order of all permissible integer compositions of the sample size having as many terms as the allowed number of stages. This optimization process may be viewed as a projected steepest-descent algorithm wherein the projection space assures that every solution is an integer composition satisfying the problem constraints and that the descent algorithm walks through a path of integer compositions in a decreasing order of objective value starting from the initial integer composition. This particular view of the solution space is helpful for constructing the initial solution sampling module. The step size in the projected steepest-descent algorithm trades off the accuracy resolution of the solution for the required number of iterations for convergence. By appropriately choosing the step size collection, it is possible to achieve both good time overhead and solution accuracy.

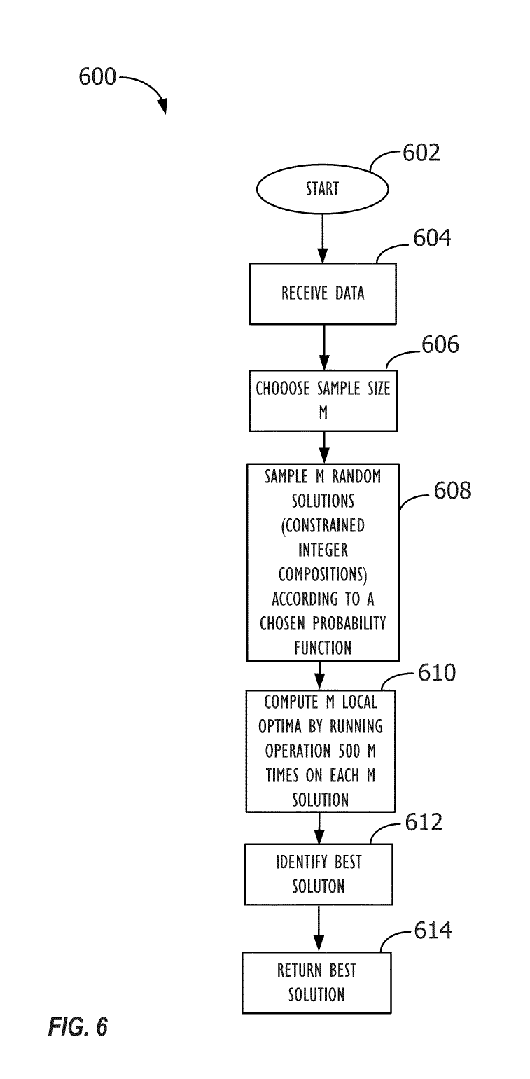

One embodiment of the initial solution sampling algorithm is outlined in operation 600 of FIG. 6. Because it is expected that the constraints on any stage in the required design are the same (e.g., same bounds on length), the solution space admits many symmetries. In the embodiment shown in FIG. 6, the symmetrical properties are exploited to effectively reduce the search space by the order of the number of symmetries and construct a sampling algorithm over such reduced search space. This is possible because every constrained integer composition can be generated from a permutation of a unique constrained integer partition of the same constraints. Therefore, to sample a constrained integer composition of the number of samples, it suffices to sample a constrained integer partition of the number of samples and a permutation on the order of the number terms in the partition.

Sampling a constrained integer partition of the number of samples can be done by imposing a lexicographical (i.e., dictionary) ordering on the constrained integer partitions. The lexicographically-ordered constrained integer partitions may then be visualized via a tree structure wherein every node in the tree represents an integer term in a partition and every path from the tree root to a terminal (i.e., leaf) node represents one constrained integer partition. The sampling algorithm may then iteratively sample one term at a time from every level in the tree in a top-down fashion. No data structure is required for the sampling as it is possible to compute the range of all integer terms at any given tree level knowing the path from the root containing all sampled parent terms. Sampling from the tree of all constrained integer partitions may be performed according to any chosen discrete probability. Once a constrained integer partition is sampled randomly, a random permutation may be chosen so as to permute the generated constrained integer partition into a constrained integer composition.

The constrained integer composition sampling algorithm is equivalent to a random top-down traversal of the tree associated with the lexicographical ordering of the space of all respective constrained integer partitions. The random tree exploration is controlled by a probability distribution that is defined via the choice of the sequence of random sampling distributions at all iterations followed by the random permutation sampling distribution.

Accordingly, operation 600 begins (block 602) by receiving data (block 604) such as the efficiency index curves and stage constraint parameters. After data is received, the operation chooses a sample size M (block 606) and then then iteratively samples M random constrained integer compositions according to a chosen probability density function (block 608).

Once M random solutions (i.e., constrained integer compositions) are sampled, the operation computes M local optima associated with the M random solutions by running operation 500 M times (block 610). Then the best solution amongst the M computed local optima is identified (block 612) and returned at block 614.

The operations of FIGS. 5-6 illustrate embodiments for staging (i.e., partitioning) the depth zone of the wellbore for fracturing. These algorithms generally seek to partition the wellbore with the objective of minimizing the sum of all intra-stage variability given one or more index curves with the presumption that each and every stage in the partition is to be fractured. However, as discussed before, when one or more stages have efficiency indices of mostly low values, the user may want to skip (i.e., not fracture) such stages. In order to allow for such skipping, the algorithms may need to be reconfigured to minimize the sum of the intra-stage variability of only the stages of interest. This may be done, in one embodiment, by taking the final solution outputted by operation 500 of FIG. 5 without performing any stage skipping, flagging the stages to be skipped, and feeding back the solution as part of the input to operation 500 while making the objective function sum over the intra-stage variability of only the unflagged stages.

In deciding which stages to flag for skipping, a user-defined minimum threshold on the average stage index (or indices for multiple input curves) may be used in one embodiment. In such a case all stages having an average index (indices) lower than the minimum threshold are flagged for skipping. The threshold may alternatively be defined with any other static of interest such the maximum allowed variability within any stage. An alternative embodiment for flagging the stages to be skipped may utilize an outlier detection algorithm that automatically flags the stages that need to be skipped. In such an embodiment, an outlier may be defined as any stage with an efficiency index distribution of values that is lower by a specific threshold than those of the most other stages. An additional alternative embodiment for stage skipping flagging may be to employ a training framework wherein a training dataset of multiple depth staging configurations are collected each along with its target stages to be flagged. The training framework may learn a classification function able to flag stages to be skipped in any never before seen staging configuration.

In addition to the need to consider skipping some stages, it may also be necessary to take into account areas close to fault(s) around which fracturing should be avoided. As discussed before it is generally preferable to skip fracturing depth ranges that are affected by faults or similar geological areas. Accordingly, to take into account faults, the operations of FIGS. 5-6 may further need to be modified.

Generally faults, defined by their center locations and proximity ranges, divide the complete depth zone up into disjointed depth subzones. In other words, the continuum of the complete depth zone is disrupted by several episodes of fault-inflicted depth subzones. A sub-problem over a non-fault-inflicted subzone may be solved by the operations of FIGS. 5-6, if a number of stages is designated for it. However, this application generally requires that only the collective number of stages be designated. Each sub-problem individually admits theoretical lower and upper bounds on the number of its possible stages. To obtain the desired number of stages, all individual stage numbers must also add up to the designated total number of stages. Hence, designation of individual stage numbers for each sub-problem is also a constrained integer composition problem. Thus to achieve the correct result which takes into account faults, a designation of stage numbers can be sampled with a similar method as the one prescribed in the operation 600 of FIG. 6. Given a designation of stage numbers, each sub-problem may be solved independently using the operation 500 of FIG. 5 or collectively the operations 500 and 600 of FIGS. 5-6.

Thus, the forgoing solutions provide embodiments for partitioning a wellbore depth zone into multiple stages automatically, accurately, and efficiently while providing the ability to take into account skipping and faults.

In the foregoing description, for purposes of explanation, specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process acts may be performed in an order different than discussed. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A non-transitory program storage device, readable by a processor and comprising instructions stored thereon to cause one or more processors to:
receive a plurality of input parameters, each input parameter relating to a wellbore in a reservoir formation;
calculate one or more efficiency indices for the wellbore based on the input parameters, wherein each of the one or more efficiency indices may vary along a length of the wellbore; and
select one or more stage locations for the wellbore, each stage having a particular length, wherein the selection is done by utilizing an optimization process used to select stage locations based at least in part on at least one of the one or more efficiency indices having a minimal total intra-stage variation along the length of the wellbore.

2. The non-transitory program storage device of claim 1, wherein one of the at least one or more efficiency indices is an absolute fracture efficiency index.

3. The non-transitory program storage device of claim 2, wherein the instructions stored thereon further cause the one or more processors to determine if the wellbore should be fractured based on the absolute fracture efficiency index.

4. The non-transitory program storage device of claim 1, wherein the instructions stored thereon further cause the one or more processors to receive one or more stage constraint inputs.

5. The non-transitory program storage device of claim 4, wherein at least one of the one or more stage constraint inputs is an input for a desired number of stages in the wellbore.

6. The non-transitory program storage device of claim 4, wherein at least one of the one or more stage constraint inputs is an input for a maximum length of stage desired or an input for a minimum length of stage desired.

7. The non-transitory program storage device of claim 4, wherein the one or more stage locations are selected at least in part based on at least one of the one or more stage constraint inputs.

8. The non-transitory program storage device of claim 1, wherein the instructions stored thereon further cause the one or more processors to determine if one or more stage locations should be skipped.

9. The non-transitory program storage device of claim 8, wherein the determination to skip one or more stage locations is made at least in part based on at least one of the one or more fracture efficiency indices.

10. The non-transitory program storage device of claim 8, wherein the determination to skip one or more stage locations is made at least in part based on a threshold for skipping stage locations along the length of the wellbore that fall below the threshold.

11. The non-transitory program storage device of claim 10, wherein the threshold specifies one or more minimum average indices for one of the at least one or more efficiency indices.

12. The non-transitory program storage device of claim 8, wherein the determination to skip one or more stage locations is made at least in part based on an outlier detection method.

13. The non-transitory program storage device of claim 8, wherein the determination to skip one or more stage locations is made at least in part based on a trained classification method.

14. The non-transitory program storage device of claim 8, wherein the determination to skip one or more stage locations is followed by an optimization of the stage locations at least based in part on the stages determined to be skipped.

15. The non-transitory program storage device of claim 1, wherein the instructions stored thereon further cause the one or more processors to determine if one or more faults are identified along the length of the wellbore.

16. The non-transitory program storage device of claim 15, wherein the one or more stage locations are selected at least in part such that areas along the length of the wellbore that are within a certain proximity to the one or more identified faults are skipped.

17. The non-transitory program storage device of claim 1, wherein the instructions stored thereon further cause the one or more processors to receive one or more of weights and cutoff values for one or more of the input parameters.

18. The non-transitory program storage device of claim 17, wherein at least one of the one or more efficiency indices is calculated based at least in part on the one or more weights and cutoff values.

19. The non-transitory program storage device of claim 1, wherein at least one of the one or more efficiency indices is calculated based at least in part on a continuous scaling function.

20. The non-transitory program storage device of claim 1, wherein the input parameters comprise one or more of reservoir attributes, geomechanical attributes, and user-defined attributes.

21. The non-transitory program storage device of claim 1, wherein the input parameters are received from at least one of a log data, core data, cutting data, or drilling operational data.

22. The non-transitory program storage device of claim 1, wherein one of the at least one or more efficiency indices is a relative fracture efficiency index.

23. The non-transitory program storage device of claim 1, wherein one of the at least one or more efficiency indices is a raw attribute value.

24. The non-transitory program storage device of claim 23, wherein one of the at least one or more efficiency indices is any linear or nonlinear combination of one or more raw attribute values.

25. A method for designing a fracture network staging operation, the method comprising:
receiving a plurality of input parameters, each input parameter relating to a wellbore in a reservoir formation;
calculating one or more efficiency indices for the wellbore based on the input parameters, wherein the one or more efficiency indices may vary along a length of the wellbore; and
selecting one or more stage locations for the wellbore, each stage having a particular length, wherein the selection is done by utilizing an optimization process used to select stage locations based at least in part on at least one of the one or more efficiency indices having a minimal total intra-stage variation along the length of the wellbore.

26. The method of claim 25, wherein one of the at least one or more efficiency indices is an absolute fracture efficiency index.

27. The method of claim 25, further comprising receiving one or more stage constraint inputs.

28. The method of claim 27, wherein the one or more stage constraint inputs include at least one of an input for a desired number of stages in the wellbore, an input for a maximum length of stage desired, and an input for a minimum length of stage desired.

29. The method of claim 27, wherein the one or more stage locations are selected at least in part based on at least one of the one or more stage constraint inputs.

30. The method of claim 25, further comprising determining if one or more stage locations should be skipped.

31. The method of claim 25, further comprising determining if a one or more faults are identified along the length of the wellbore.

32. The method of claim 31, wherein the one or more stage locations are selected at least in part such that areas along the length of the wellbore that are within a certain proximity to the one or more identified faults are skipped.

33. The method of claim 25, further comprising receiving one or more of weights and cutoff values for one or more of the input parameters.

34. The method of claim 33, wherein at least one of the one or more efficiency indices is calculated based at least in part on the one or more weight and cutoff values.

35. The method of claim 25, wherein at least one of the one or more efficiency indices is calculated based at least in part on one or more scaling functions.

36. The method of claim 25, wherein the input parameters comprise one or more of reservoir attributes, geomechanical attributes, and user-defined attributes.

37. The method of claim 25, wherein one of the at least one or more efficiency indices is a relative fracture efficiency index.

38. The method of claim 25, wherein one of the at least one or more efficiency indices is a raw attribute value.

39. The method of claim 25, wherein one of the at least one or more efficiency indices is any linear or nonlinear combination of one or more raw attribute values.

40. A system, comprising:
a memory;
a display device; and
a processor operatively coupled to the memory and the display device and adapted to execute program code stored in the memory to:
receive a plurality of input parameters, each input parameter relating to a wellbore in a reservoir formation;
calculate one or more efficiency indices for the wellbore based on the input parameters, wherein the one or more efficiency indices may vary along a length of the wellbore; and
select one or more stage locations for the wellbore, each stage having a particular length, wherein the selection is done by utilizing an optimization process used to select stage locations based at least in part on at least one of the one or more efficiency indices having a minimal total intra-stage variation along the length of the wellbore.

41. The system of claim 40, wherein one of the at least one or more efficiency indices is an absolute fracture efficiency index.

42. The system of claim 41, wherein the processor is further adapted to execute program code stored in the memory to determine if the wellbore should be fractured based on the absolute fracture efficiency index.

43. The system of claim 40, wherein the processor is further adapted to execute program code stored in the memory to receive receiving one or more stage constraint inputs.

44. The system of claim 43, wherein the one or more stage constraint inputs include at least one of an input for a desired number of stages in the wellbore, an input for a maximum length of stage desired, and an input for a minimum length of stage desired.

45. The system of claim 43, wherein the one or more stage locations are selected at least in part based on at least one of the one or more stage constraint inputs.

46. The system of claim 40, wherein the processor is further adapted to execute program code stored in the memory to determine if one or more stage locations should be skipped.

47. The system of claim 40, wherein the processor is further adapted to execute program code stored in the memory to determine if a one or more faults are identified along the length of the wellbore.

48. The system of claim 47, wherein the one or more stage locations are selected at least in part such that areas along the length of the wellbore that are within a certain proximity to the one or more identified faults are skipped.

49. The system of claim 40, wherein the processor is further adapted to execute program code stored in the memory to receive one or more of weight and cutoff values for one or more of the input parameters.

50. The system of claim 49, wherein at least one of the one or more efficiency indices is calculated based at least in part on the one or more weight and cut off values.

51. The system of claim 40, wherein the processor is further adapted to execute program code stored in the memory to receive one or more of scaling functions for one or more of the input parameters.

52. The system of claim 51, wherein at least one of the one or more efficiency indices is calculated based at least in part on the one or more scaling functions.

53. The system of claim 40, wherein the input parameters comprise one or more of reservoir attributes, geomechanical attributes, and user-defined attributes.

54. The system of claim 40, wherein one of the at least one or more efficiency indices is a relative fracture efficiency index.

55. The system of claim 40, wherein one of the at least one or more efficiency indices is a raw attribute value.

56. The system of claim 40, wherein one of the at least one or more efficiency indices is any linear or nonlinear combination of one or more raw attribute efficiency values.
